(19) United States
(12) Patent Application Publication
(10) Pub. No.: US 2016/0126740 A1
(43) Pub. Date: May 5, 2016

(54) POWER PLANT

(71) Applicant: GE Jenbacher GmbH & Co OG, Jenbach (AT)

(72) Inventors: Hang LU, Freising (DE); Parag DHARMADHIKARI, Neufahrn bei Freising (DE)

(21) Appl. No.: 14/922,505

(22) Filed: Oct. 26, 2015

(30) Foreign Application Priority Data
Oct. 31, 2014 (AT) A 804/2014

(51) Int. Cl. H02J 3/32; H02P 9/00; H02P 9/04; H02K 7/18

(52) U.S. Cl. CPC H02J 3/32; H02K 7/1815; H02P 9/00; H02P 9/04

(57) ABSTRACT

A power plant, in particular a genset, comprising an internal combustion engine and a main generator drivable by the internal combustion engine, wherein the main generator is electrically connected to a power grid, the power plant further comprising an auxiliary generator drivable by the internal combustion engine, wherein a voltage connector of the auxiliary generator is connected with a first alternating voltage connector of a voltage converter, wherein a direct voltage connector of the voltage converter is connected with an electrical energy storage, wherein a second alternating voltage connector of the voltage converter is connected to the power grid.

The present invention is directed to a power plant with the features of the preamble of claim 1 and a method of operating a power plant with the features of the preamble of claim 7.

A power plant is used to supply power to a power grid connected to the power plant. It may be in the form of a genset comprising an internal combustion engine and an electrical main generator being mechanically coupled to and driven by the internal combustion engine and being electrically connected to the power grid. Typically, the internal combustion engine is in the form of a reciprocating gas engine which often has a relatively small inertia. In order to better respond to transient load situations in the power grid, it is also known from the prior art to provide an electrical energy storage electrically connected to an electrical auxiliary generator via an alternating voltage to direct voltage power converter, said auxiliary generator being mechanically coupled to and driven by the internal combustion engine. During times of fluctuations in electrical loads connected to the power grid the electrical energy storage is charged or discharged, thereby either absorbing excess electrical energy from the auxiliary generator or providing electrical energy to the auxiliary generator. Although the known power plants allow for stabilized gensets at fluctuating load situations, a more effective and very fast response to other grid events (e.g. a short-circuit fault or low voltage ride through) is desirable.

The objective of the present invention is to improve the response of the power plant to load fluctuations or other grid events, such as short-circuit faults or low voltage ride through (LVRT) events.

The objective is being achieved by a power plant according to claim 1 and a method according to claim 7. Advantageous embodiments are given in the dependent claims.

According to the invention, a second alternating voltage terminator of the power converter is connected to the power grid. Thereby, the power converter is electrically directly connected to the power grid. By way of this direct connection the responsiveness of the power plant in reaction to load fluctuations or other grid events can be improved. In particular, it is possible to feed electrical energy directly from the energy storage to the power grid.

Moreover it is possible to operate both generators (main generator and auxiliary generator) to feed electrical energy to the grid, thereby achieving a power split between these generators. This splitting of the power to be provided on the one hand by the main generator and on the other hand by the auxiliary generator improves stability for all machines involved (internal combustion engine, main generator and auxiliary generator) and allows to keep these machines under control and e.g. not to over-speed or under-speed during grid events. This is in particular important in cases where the power grid has to remain connected to the power plant during grid events, e.g. due to grid code requirements.

With the proposed solution, a genset with an internal combustion engine or gas turbine can be cranked using the electrical energy storage and the auxiliary generator with higher rotational speed compared to a standard start procedure with a battery, because the power of the auxiliary generator is higher than that of a normal starter, so that the engine can be started more quickly.

Further advantages of the invention include:
fast response to load fluctuations and other grid events;
enhanced performance stability;
compliance to grid code and load requirements;
improve the load rejection and load acceptance performance in case the genset is operated in a isolated power grid;
over-speeding control, thereby avoiding a separate breaking mechanism;
redundancy due to the auxiliary generator in case the main generator is under maintenance;
cranking mechanism can be avoided;
very quick startup with fast ramp;
control independent of grid frequency as the auxiliary generator has no direct connection to the power grid but it is connected to the power grid via the power converter;
absorbing the shocks in the power grid by smoothening of step loads and not passing grid transients towards the engine.

It can be provided that a power ratio of a nominal power of the main generator to a nominal power of the auxiliary generator is at least 1.5, wherein the power ratio preferably is approximately 4. The main generator may e.g. have a nominal power of 8 MW, and the auxiliary generator may have a nominal power of 2 MW. Thus, in this example the main generator and the auxiliary generator provide an overall electrical output of 10 MW. The main generator is directly connected to the power grid and the auxiliary generator is connected to the power grid via the power converter. By means of this configuration only a relatively small part of the overall electrical output has to pass through the power converter. Therefore, the power converter is more efficient compared to configurations in which all of the overall electrical output has to pass through the power converter. Further, it is possible to use smaller and thus cheaper power converters which have lower cooling requirements.

According to an advantageous embodiment, it can be provided that the main generator and the auxiliary generator are formed as separate electrical generators. Both the main generator and the auxiliary generator may mechanically be coupled to a motor shaft of the internal combustion engine.

It can also be provided that the main generator and the auxiliary generator are formed as one single electrical generator drivable by the internal combustion engine, wherein the main generator comprises a main winding system arranged at a stator of the generator and the auxiliary generator comprises an auxiliary winding system arranged at the stator. In a configuration according to this embodiment no separate physical auxiliary generator is required. The conductors of the winding systems may be isolated by varnish coatings.

It can be provided that a winding ratio of the main winding system to the auxiliary winding system is at least 1.5, wherein the winding ratio preferably is approximately 4. In such configurations the winding ratio corresponds to the ratio of nominal power of the main generator to the nominal power of the auxiliary generator.

According to an advantageous embodiment, there is provided a control device, wherein at least one operating state of the power grid and/or the internal combustion engine and/or the main generator and/or the auxiliary generator and/or the energy storage can be signaled to the control device via at least one signal line, wherein the power converter is controllable by the control device via a control line in dependency of the at least one operating state. Via the control line the control device controls the Insulated-gate bipolar transistor (IGBT) in the power converter circuits to control the power flow direction and frequency.

With respect to the method, it is proposed that a second alternating voltage terminator of the power converter is connected to the power grid, wherein in dependency of at least one operating state of the power grid and/or the internal combustion engine and/or the main generator and/or the auxiliary generator and/or the energy storage a flow direction of electrical energy through the power converter is controlled.

By means of controlling the flow direction of electrical energy through the power converter it is for example possible to actively break the internal combustion engine and not unnecessarily dissipate excess energy provided by the genset.

The following electrical energy flows or power flows can be achieved with the proposed power plant:
the power flow is from the auxiliary generator via the power converter to the power grid in normal operation state;
the power is from the auxiliary generator and electrical energy storage via the power converter to the power grid, if the power demand from the power grid is higher than produced by the genset;
the power is from the auxiliary generator to the electrical energy storage via the power converter, if the power demand from the power grid is lower than produced by the genset and the electrical energy storage has capacity to absorb the energy;
the power is from the electrical energy storage and/or from the power grid to the auxiliary generator for starting up the internal combustion engine;
the power can also be transferred from the power grid directly via the power converter to the electrical energy storage.

It can be provided that if a power demand of the power grid is higher than an overall electrical output provided by the main generator and the auxiliary generator electrical energy stored in the energy storage is fed through the power converter to the power grid, preferably by controlling the power converter. If the power demand of the power grid is higher than the actual power of the genset, it can also be provided to increase the engine power of the internal combustion engine, thereby delivering electrical energy from the energy storage to the power grid.

Further it can be provided that if a power demand of the power grid is lower than an electrical output provided by the main generator and/or the auxiliary generator electrical energy is fed from the power grid and/or the auxiliary generator through the power converter to the energy storage, preferably by controlling the power converter. If the power demand of the power grid is lower than the actual power of the genset, it can also be provided to decrease the engine power of the internal combustion engine, thereby charging the energy storage from the power grid.

In particular for starting up the internal combustion engine it can be provided that for starting up the internal combustion engine with the auxiliary generator electrical energy is fed from the energy storage and/or the power grid through the power converter to the auxiliary generator, preferably by controlling the power converter.

Further details and advantages of the invention will become apparent in light of the accompanying drawings, wherein:

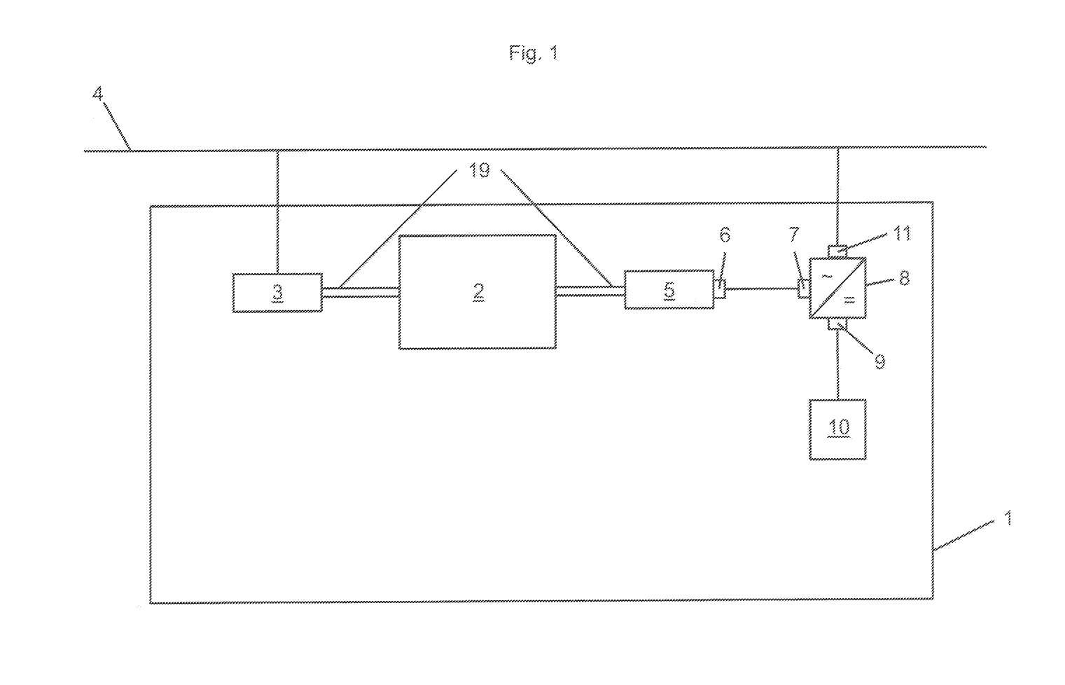

FIG. 1 shows a schematic block diagram of a proposed power plant,

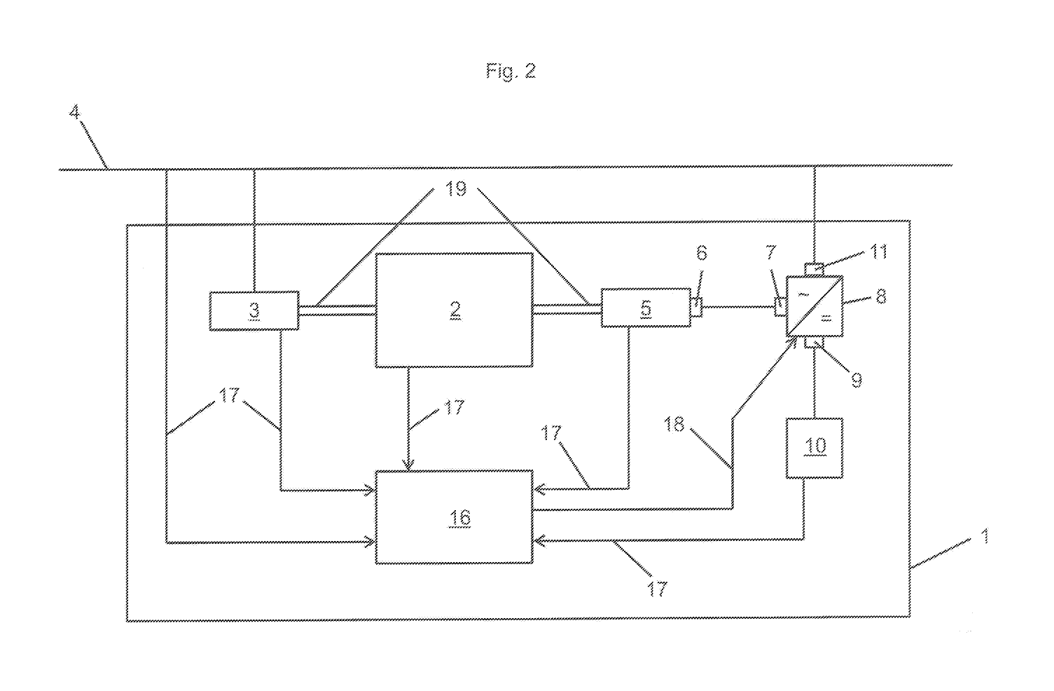

FIG. 2 shows the power plant according to FIG. 1 complemented by a control device,

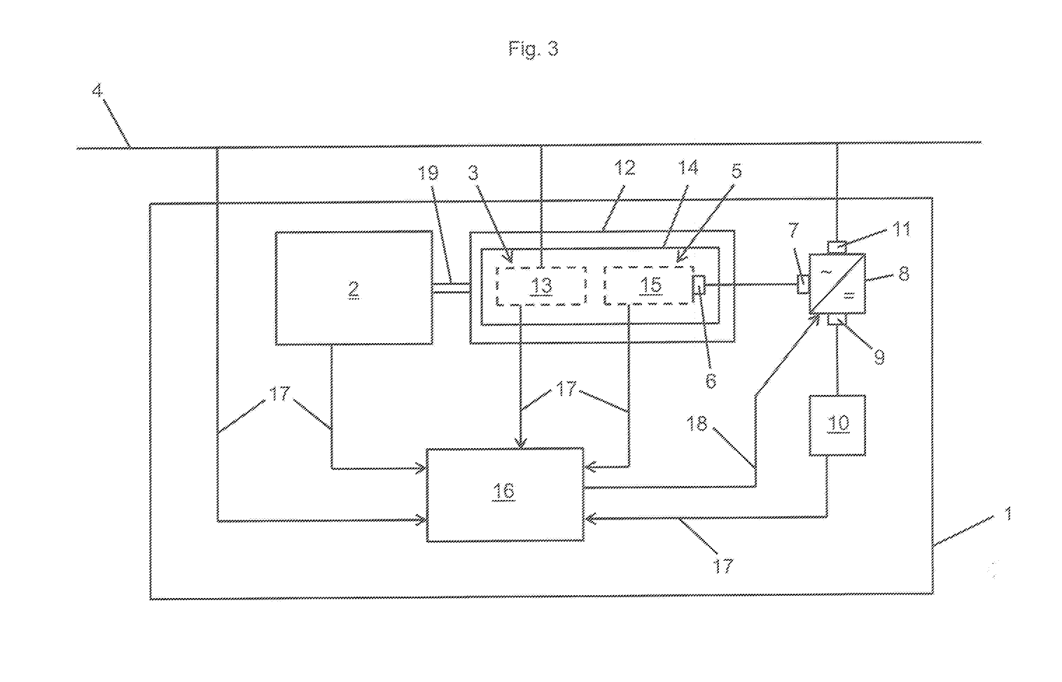

FIG. 3 shows another embodiment of a proposed power plant and

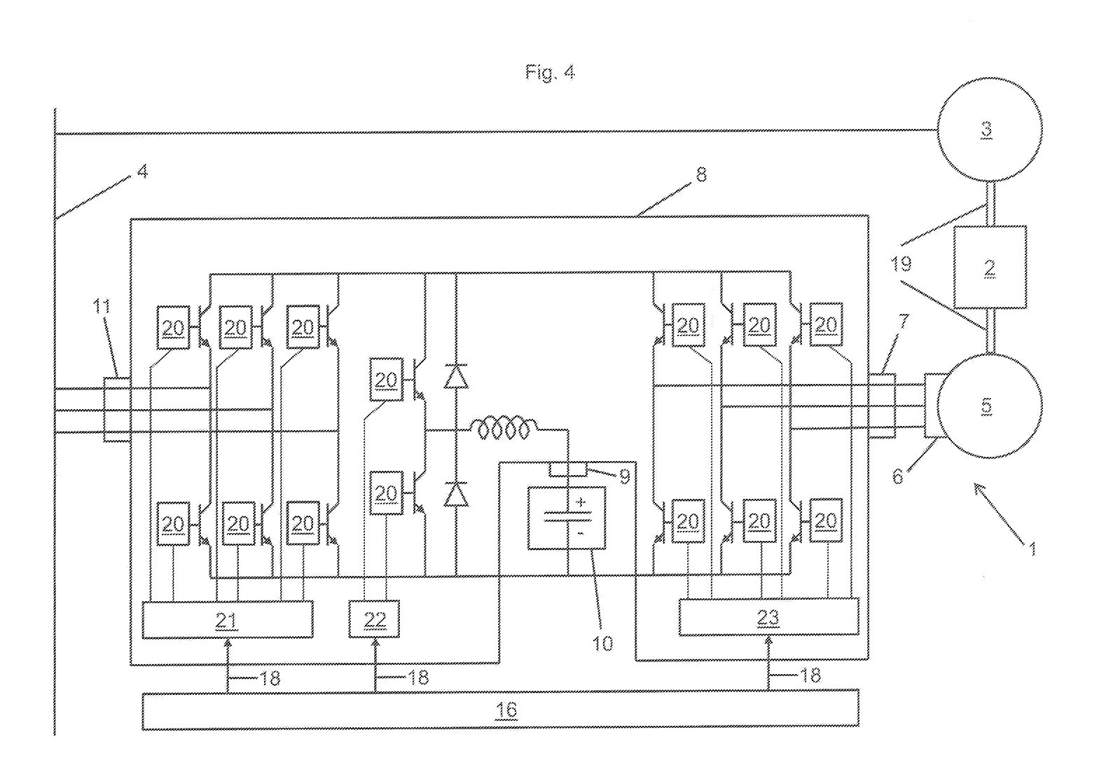

FIG. 4 shows a detailed schematic diagram of a power converter.

FIG. 1 shows a schematic block diagram of a proposed power plant 1 in the form of a genset. The power plant 1 comprises an internal combustion engine 2 in the form of a reciprocating gas engine. The internal combustion engine 2 has a motor shaft 19 to which a main generator 3 and an auxiliary generator 5 are mechanically coupled. The main generator 3 and the auxiliary generator 5 are drivable by the internal combustion engine 2 via the motor shaft 19. The main generator 3 is electrically connected to a power grid 4 and in operational state delivers electrical energy to the power grid 4.

The auxiliary generator 5 has a terminator 6 which is electrically connected with a first alternating voltage terminator 7 of a power converter 8. A direct voltage terminator 9 of the power converter 8 is electrically connected with an electrical energy storage 10. For charging the electrical energy storage 10, electrical energy flows from the terminator 6 of the auxiliary generator 5 to the first alternating voltage terminator 7 of the power converter 8. The power converter 8 converts the alternating voltage provided by the auxiliary generator 5 into direct voltage and provides this converted electrical energy via its direct voltage terminator 9 to the energy storage 10. In this example the flow direction of electrical energy through the power converter 8 is from the first alternating voltage terminator 7 to the direct voltage terminator 9.

The power converter 8 further has a second alternating voltage terminator 11, which is electrically connected with the power grid 4. By this, the energy storage 10 can also be charged from the power grid 4 as electrical energy flows from the power grid 4 to the second alternating voltage terminator 11 of the power converter 8. The power converter 8 converts the alternating voltage provided by the power grid 4 into direct voltage and provides this converted electrical energy via its direct voltage terminator 9 to the energy storage 10. In this example the flow direction of electrical energy through the power converter 8 is from the second alternating voltage terminator 11 to the direct voltage terminator 9.

In order to support the internal combustion engine 2 e.g. for starting reasons or if the power demand of the power grid 4 has a sudden peak, the energy storage 10 may provide stored energy to the auxiliary generator 5. In this example the auxiliary generator 5 would operate as an additional motor supporting the internal combustion engine 2 and the flow direction of electrical energy through the power converter 8 would be from the direct voltage terminator 9 to the first alternating voltage terminator 7.

If there is a sudden power demand from the power grid 4, the energy storage 10 may provide stored energy directly to the power grid 4. In this example the flow direction of electrical energy through the power converter 8 would be from the direct voltage terminator 9 to the second alternating voltage terminator 11.

As an example, the main generator 3 may have a nominal power of 10 MW and the auxiliary generator 5 may have a nominal power of 2 MW. The power converter 8 may be able to convert about 2 MW at about 600 V to about 1200 V from alternating voltage into direct voltage and vice versa. The energy storage 10 may be in the form of supercapacitors with a capacity of about 16 F.

FIG. 2 shows a proposed power plant 1 according to FIG. 1. In addition to the power plant 1 of FIG. 1 there is provided a control device 16. Via signal lines 17 operational states of the internal combustion engine 2, the main generator 3, the auxiliary generator 5, the power grid 4 and the energy storage 10 are signaled to the control device 16. Via at least one control line 18 from the control device 16 to the power converter 8 the control device 16 commands the power converter 8 such that a flow direction of electrical energy through the power converter 8 is controlled.

In this example, the following operating states are signaled via signal lines 17 to the control device 16: power demand from the power grid 4, actual power of main generator 3, actual power of auxiliary generator 5, engine speed of internal combustion engine 2 and actual energy and/or voltage stored in the energy storage 10. Via the at least one control line 18 the power converter 8 is commanded by the control device 16 in dependency of the operating states.

FIG. 3 shows another embodiment of a proposed power plant 1. In this example, both the main generator 3 and the auxiliary generator 5 are formed as one single electrical generator 12 drivable by the internal combustion engine 2 via its motor shaft 19. The electrical generator 12 comprises a stator 14 which is equipped with a main winding system 13 and an auxiliary winding system 15. The main generator 3 comprises the main winding system 13 and the auxiliary generator 5 comprises the auxiliary winding system 15. Such a configuration has the advantage that only one physical electrical generator 12 is necessary.

FIG. 4 shows another example of a proposed power plant 1. An example of a possible power converter 8 is shown in more detail. A flow direction of electrical energy through the power converter 8 via its first alternating voltage terminator 7, its direct voltage terminator 9 and its second alternating voltage terminator 11 is controlled by way of the control device 16, control lines 18, line side quad converter 21, storage controller 22, generator side quad converter 23 and driver cards 20 for corresponding insulated-gate bipolar transistors (IGBT). The line side quad converter 21, the storage controller 22 and the generator side quad converter 23 are secondary controllers between the main control device 16 and the IGBT driver cards 20. Via the driver cards 20, the gate-pins of the transistors (IGBTs) are connected to the secondary controllers (line side quad converter 21, storage controller 22 and generator side quad converter 23).

Using digital voltage signals (e.g. 0-12 V), the secondary controllers can control the transistors between an open and a closed operation state, so that the electrical energy flow can be controlled in the power converter 8. In particular, a flow direction of electrical energy through the power converter 8 via its first alternating voltage terminator 7, its direct voltage terminator 9 and its second alternating voltage terminator 11 can be controlled.

By this, it is for example possible that if a power demand of the power grid 4 is higher than an overall electrical output provided by the main generator 3 and the auxiliary generator 5, electrical energy stored in the energy storage 10 is fed through the power converter 8 to the power grid 4, via the direct voltage terminator 9 and the second alternating voltage terminator 11.

It is also possible that if a power demand of the power grid 4 is lower than an electrical output provided by the main generator 3 and/or the auxiliary generator 5, electrical energy is fed from the power grid 4 and/or the auxiliary generator 5 through the power converter 8 to the energy storage 10, via the second alternating voltage terminator 11 and/or the first alternating voltage terminator 7 and the direct voltage terminator 9.

It is further possible that for starting up the internal combustion engine 2 with the auxiliary generator 5, electrical energy is fed from the energy storage 10 and/or the power grid 4 through the power converter 8 to the auxiliary generator 5, via the direct voltage terminator 9 and/or the second alternating voltage terminator 11 and the first alternating voltage terminator 7.

1. A power plant, in particular a genset, comprising an internal combustion engine and a main generator drivable by the internal combustion engine, wherein the main generator is electrically connected to a power grid, the power plant further comprising an auxiliary generator drivable by the internal combustion engine, wherein a terminator of the auxiliary generator is connected with a first alternating voltage terminator of a power converter, wherein a direct voltage terminator of the power converter is connected with an electrical energy storage, wherein a second alternating voltage terminator of the power converter is connected to the power grid.

2. A power plant according to claim 1, wherein a power ratio of a nominal power of the main generator to a nominal power of the auxiliary generator is at least 1.5, wherein the power ratio preferably is approximately 4.

3. A power plant according to claim 1, wherein the main generator and the auxiliary generator are formed as separate electrical generators.

4. A power plant according to claim 1, wherein the main generator and the auxiliary generator are formed as one single electrical generator drivable by the internal combustion engine, wherein the main generator comprises a main winding system arranged at a stator of the generator and the auxiliary generator comprises an auxiliary winding system arranged at the stator.

5. A power plant according to claim 4, wherein a winding ratio of the main winding system to the auxiliary winding system is at least 1.5, wherein the winding ratio preferably is approximately 4.

6. A power plant according to claim 1, wherein there is provided a control device, wherein at least one operating state of the power grid and/or the internal combustion engine and/or the main generator and/or the auxiliary generator and/or the energy storage can be signaled to the control device via at least one signal line, wherein the power converter is controllable by the control device via a control line in dependency of the at least one operating state.

7. A method of operating a power plant, in particular according to claim 1, comprising an internal combustion engine and a main generator drivable by the internal combustion engine, wherein the main generator is electrically connected to a power grid, the power plant further comprising an auxiliary generator drivable by the internal combustion engine, wherein a terminator of the auxiliary generator is connected with a first alternating voltage terminator of a power converter, wherein a direct voltage terminator of the power converter is connected with an electrical energy storage, characterized in that a second alternating voltage terminator of the power converter is connected to the power grid, wherein in dependency of at least one operating state of the power grid and/or the internal combustion engine and/or the main generator and/or the auxiliary generator and/or the energy storage a flow direction of electrical energy through the power converter is controlled.

8. A method according to claim 7, wherein if a power demand of the power grid is higher than an overall electrical output provided by the main generator and the auxiliary generator electrical energy stored in the energy storage is fed through the power converter to the power grid, preferably by controlling the power converter.

9. A method according to claim 7, wherein if a power demand of the power grid is lower than an electrical output provided by the main generator and/or the auxiliary generator electrical energy is fed from the power grid and/or the auxiliary generator through the power converter to the energy storage, preferably by controlling the power converter.

10. A method according to claim 7, wherein for starting up the internal combustion engine with the auxiliary generator electrical energy is fed from the energy storage and/or the power grid through the power converter to the auxiliary generator, preferably by controlling the power converter.
